(19) United States
(12) Patent Application Publication
(10) Pub. No.: US 2010/0270332 A1
(43) Pub. Date: Oct. 28, 2010

(54) EPOXY DISPENSER

(76) Inventor: John F. Trout, Geneva, IL (US)

Correspondence Address: TAYLOR IP, P.C., P.O. Box 560, 142. S Main Street, Avilla, IN, 46710, US

(21) Appl. No.: 12/430,398

(22) Filed: Apr. 27, 2009

(51) Int. Cl. B67D 5/56; B67D 5/34

(52) U.S. Cl. 222/145.1; 222/137; 222/145.5; 222/1

(57) ABSTRACT

A dispenser for dispensing a fluid under high pressure includes: a housing; two valves within the housing and arranged parallel relative to one another; an actuator assembly within the housing and including a single rigid shaft which is connected to the valves and is configured for simultaneously opening and closing the valves.

### BACKGROUND OF THE INVENTION

1. Field of the Invention

The present invention relates to dispensers, and, more particularly, to epoxy dispensers.

2. Description of the Related Art

Fluid dispensers include dispensers for mixing two reactive components and ejecting the mixed components, such as at a high discharge pressure. Such fluid dispensers include epoxy dispensers. Epoxy resin can be used in construction applications. For instance, an epoxy compound may be injected into the void of a fault in concrete, the fault thereby being sealed and further cracking being inhibited. The epoxy resin is formed when the two reactive components are mixed in a mixer. The flow of the reactive components prior to mixing in the mixer is regulated by valves associated with separate fluid flow lines. The valves, such as ball valves, are actuated by different components, and thus not by a single shaft.

What is needed in the art is an epoxy dispenser with a simple mechanism for actuating simultaneously the two valves associated with the two flowable materials of the epoxy.

### SUMMARY OF THE INVENTION

The present invention provides an epoxy dispenser with only one shaft for connecting to and simultaneously actuating the two valves associated with the two flowable materials of the epoxy.

The invention in one form is directed to a dispenser for dispensing a fluid under high pressure, the dispenser including: a housing; two valves within the housing and arranged parallel relative to one another; an actuator assembly within the housing and including a single rigid shaft which is connected to the valves and is configured for simultaneously opening and closing the valves.

The invention in another form is directed to a method of dispensing a fluid under high pressure, the method including the steps of: providing a dispenser including a housing, two valves within the housing and arranged parallel relative to one another, and an actuator assembly within the housing and including a single rigid shaft; connecting the shaft to the valves; opening simultaneously the valves with the shaft; and closing simultaneously the valves with the shaft.

An advantage of the present invention is it uses a single shaft for connecting to and simultaneously actuating the two valves associated with the base and catalyst components of the epoxy resin.

Another advantage is that the epoxy dispenser has a reduced amount of retaining rings, seals, and bushings.

Yet another advantage is a lack of play or wiggle between certain parts of the epoxy dispenser.

Yet another advantage is the efficient and simple way of transmitting drive power from the air cylinder assembly to the pivoting ball valves.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective, partial schematic view of an epoxy dispensing system according to an embodiment of the present invention;

FIG. 2 is an exploded, perspective view of the dispenser of FIG. 1;

FIG. 3 is an exploded, side view of the valve gear of the dispenser of FIG. 1;

FIG. 4 is an end view of another embodiment of the valve shaft according to the present invention;

FIG. 5 is a side view of a housing half of FIG. 1;

FIG. 6 is a bottom view of the housing half of FIG. 5;

FIG. 7 is a fluid inlet end view of the housing half of FIG. 5;

FIG. 8 is a perspective view of the endplate of the dispenser of FIG. 1;

FIG. 9 is a perspective view of another embodiment of the ball valve according to the present invention;

FIG. 10 is a fragmentary, perspective view of another embodiment of the dispenser according to the present invention; and

FIG. 11 is a cross-sectional view of another embodiment of the dispenser according to the present invention, the cross-section being taken along a plane extending through the top dead center and bottom dead center of the dispenser.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

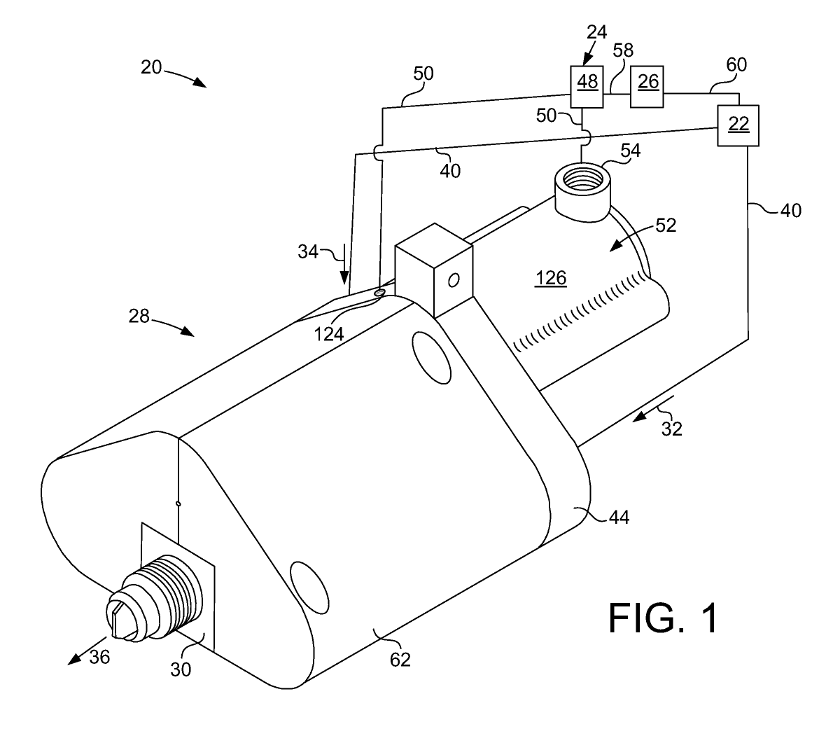

Referring now to the drawings, and more particularly to FIG. 1, there is shown an epoxy dispensing system 20 which generally includes a resin supply machine 22, an air supply arrangement 24, a remote trigger assembly 26, and an epoxy dispenser 28. The epoxy dispensing system 20, and particularly dispenser 28, can be used, e.g., in construction applications, such as filling cracks or joints in concrete. The epoxy resin that is dispensed from dispenser 28 is formed from flowable materials that are a base and a catalyst (the reactive components forming the epoxy resin). The base and catalyst components are separately supplied to dispenser 28 and mixed by dispenser 28 in an outlet nozzle block 30 to form the epoxy resin, which is then dispensed from dispenser 28 as the desired product for use in a construction application. The reactive components are shown by their flow direction designated by arrows 32 and 34. The epoxy resin is shown by its flow direction designated by arrow 36, the epoxy resin 36 exiting outlet nozzle 30.

Machine 22 includes devices for metering and proportioning the base and the catalyst that are supplied to dispenser 28. Machine 22 can supply the base and catalyst materials to dispenser 28 under high pressure. For instance, the base and catalyst can be supplied to dispenser 28 such that the pressure on each valve 38 is as high as about 2000 psi; typically such pressure can be 400-500 psi. Machine 22 can include or be connected to containers which separately contain the base and catalyst. Two hoses 40 connect machine 22 to dispenser 28. The flowable base and catalyst 32, 34 respectively flow from machine 22 through the hoses 40 to dispenser 28 and are thus maintained separate by the hoses 40. The hoses 40 can each be, for example, twenty to thirty feet long, which thus allows the operator of dispenser 28 freedom of movement. Dispenser 28 can for example be attached to the end of an elongate rod (not shown), which can also be referred to as a stem, like the stem of a golf club. A remote trigger assembly 26 can be attached to one end of the stem and held in hand by an operator, and the opposite end of the stem can be attached to the neck of the endplate 44 of dispenser 28 using a quick pin (not shown) which is fastened in two blind holes 46 in neck (or a single through-hole 46 in neck). As such, the remote trigger assembly 26 can be, for instance, at about waist height of an operator, while dispenser (on the other end of the stem) can extend toward the ground during use.

Air supply arrangement 24 generally includes an air supply device 48 and hoses 50 which connect to dispenser 28. Air supply device 48 serves to supply air through hoses 50 to an air cylinder assembly 52 of dispenser 28. One hose 50 supplies air to inlet 54 of air cylinder assembly 52, and the other hose 50 supplies air to inlet 124A of hole 124 of endplate 44.

Remote trigger assembly 26 is operated by the operator of the epoxy dispensing system 20. Trigger assembly 26 selectively triggers a supply of air from air supply arrangement 24 to dispenser 28 so as to open and close valves 38 of dispenser 28. More specifically, trigger assembly 26 triggers air supply arrangement 24 to insert air through the hoses 50. Signal line 58 shows the path, such as via radio signals or hardwire, that input control signals travel from remote trigger assembly 26 to air supply arrangement 24. Optionally, trigger assembly 26 can be used to operate machine 22, such as when to supply and shut off the base and catalyst components (the reactive components 32, 34 forming the epoxy resin 36) coming from machine 22. A corresponding input control signal line 60 shows the path, such as via radio signals or hardwire, input control signals can travel from remote trigger assembly 26 to machine 22.

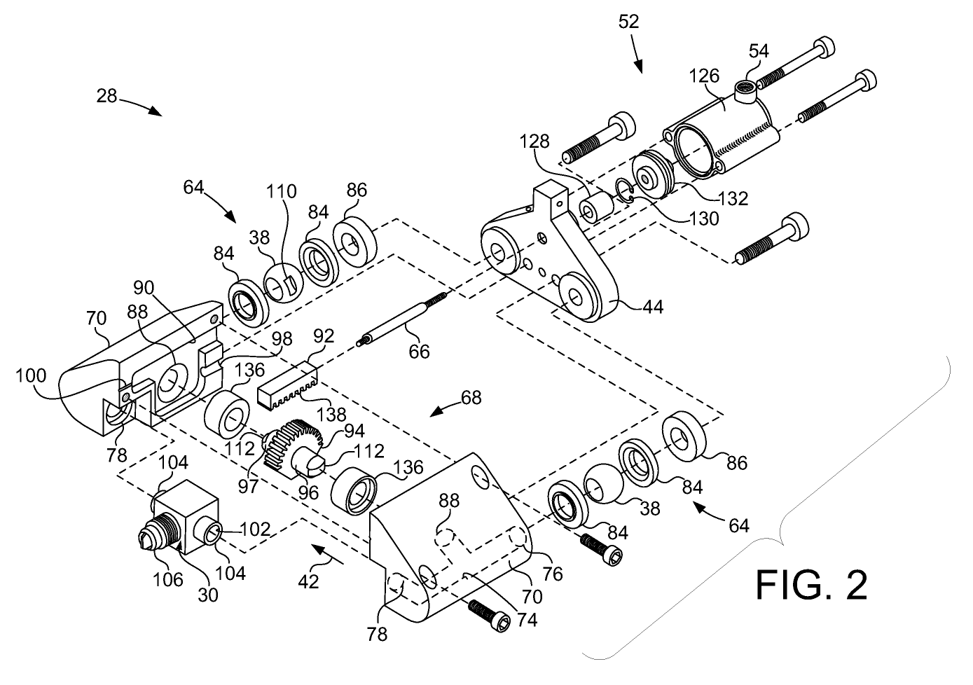

Referring also to FIGS. 2-11, dispenser 28 is for dispensing a fluid (the epoxy resin) under high pressure. More specifically, the dispenser 28 is configured for receiving the base and catalyst 32, 34 from machine 22 through hoses 40, for mixing the base and catalyst 32, 34 together to form the epoxy resin 36, and for dispensing the epoxy resin therefrom. Dispenser 28 includes a housing 62, a nozzle block 30, two valve assemblies 64, an endplate 44, an air cylinder assembly 52, a rod 66, and an actuator assembly 68. FIG. 10 shows an embodiment of dispenser 28 which has several pieces broken away for illustrative purposes. For instance, FIG. 10 does not show housing 62, rack gear 92, valve gear 94, rod 66, a right bushing 136, and connecting bolts. It is understood in FIG. 10 that the structural pieces shown are situated relative to one another as they would be if the omitted structural pieces were shown in FIG. 10.

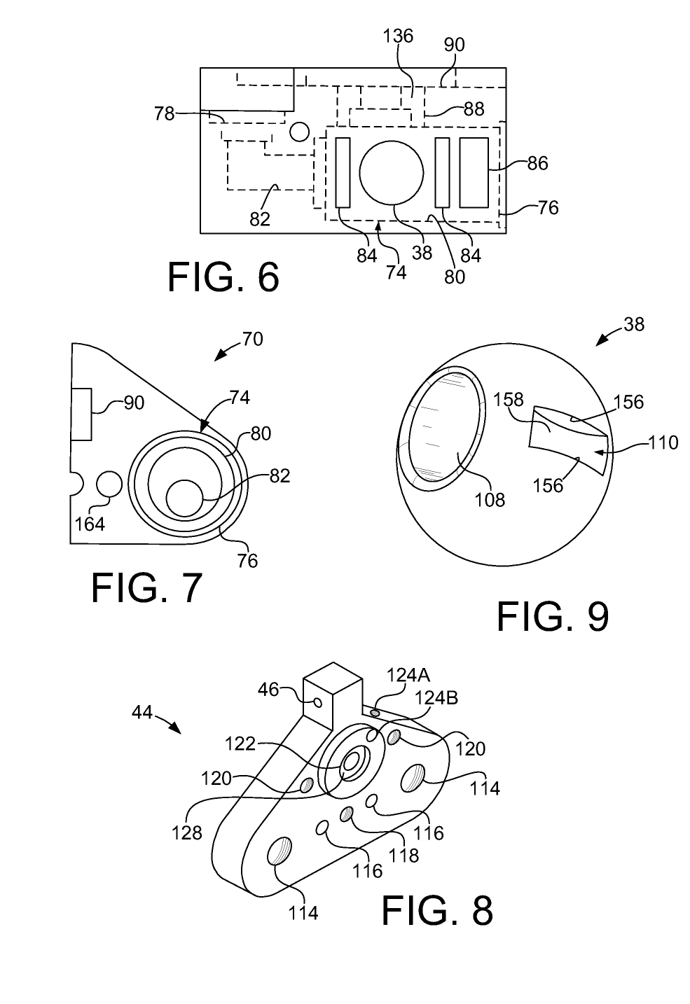

Housing 62 includes two halves 70. The two halves 70 are a left valve housing half 70, and a right valve housing half 70. Unless stated otherwise, left and right valve housing halves 70 mirror each other and are thus substantially similar to one another; thus, a description of one half 70 serves as a description of the other half 70. The left half 70 is the left half of housing 62 shown in FIG. 2, and the right half 70 is the left half of housing 62 shown in FIG. 2. Further, FIGS. 5, 6, and 7 show the left housing half 70 of FIG. 2 from various points of view. FIG. 5 shows left half 70 from the exterior of left half 70, the broken lines thus showing features that are actually hidden from view from the exterior. The features shown in broken lines in FIG. 6 are also hidden from view from the bottom (items 38, 84, and 86 are also hidden from view from the bottom but for clarity are shown schematically in solid lines). Housing halves 70 can be connected together using bolts, as shown in FIG. 2. Each housing half 70 can be formed by casting a blank, and the various holes and cavities can be formed, cut, drilled, and tapped as necessary from the blank. Each housing half 70, for example, includes an L-shaped cavity 74 with an inlet 76 and an outlet 78. Each such cavity 74 includes two bores 80, 82, one being larger in diameter than the other, as shown in FIGS. 2, 5, 6, and 7 (FIGS. 2, 5, and 6 show cavity 74 in broken lines). The larger diameter bore 80 houses the ball valve 38, the ball valve seats 84, and the ball valve spacer 86. The smaller diameter bore 82 has a center point which is lower than the center point of the larger diameter bore 80, as indicated in FIGS. 5 and 7. Surrounding each inlet hole 76 can be an O-ring seat for accommodating an O-ring seal. Similarly, surrounding each outlet hole 78 can be an O-ring seat for accommodating an O-ring seal. Whether or not a trunnion 104 is used with nozzle 30, a seal can be used at the junction of nozzle block 30 and housing halves 70. Further, each housing half 70 includes a centrally located hole 88 so that actuator assembly 68 can couple with a respective ball valve 38. FIG. 6 shows schematically a bushing 128 disposed in hole 88. Together housing halves 70 form another cavity 90, which can be referred to as the central cavity 90. Central cavity 90 houses actuator assembly 68. Central cavity 90 can have, as shown in FIGS. 2, 5, 6, 7, and 11, an area shaped to accommodate rack gear 92 and an area shaped to accommodate valve gear 94. The area for the rack gear 92 can have an elongate shape which serves as a slide area for rack gear 92; thus each housing half 70 also includes a slide area for rack gear 92. That is, rack gear 92, valve gear 94, and valve shaft 96 are disposed within central cavity 90, which is generally between the cavities 74 housing the valve assemblies 64. Each housing half 70 can define a grease insertion portion 98; when these insertion portions 98 are brought together as halves are brought together, a generally cylindrical hole 98 can be formed. On the other hand, the housing 62 need not include such a grease insertion hole 98; rather, the grease can be inserted by opening up the housing 62 (detaching housing halves 70 from one another) and inserting the grease manually into central cavity 90. Alternatively, hole 98 can have a diameter substantially the same as outlet 100 and serve as a grease inlet and/or outlet hole. Each housing half 70 can also define a grease overflow portion 100 such that when the housing halves 70 are brought together a grease overflow outlet 100 is formed. The grease lubricates the parts of actuator assembly 68 as well the movement of rod 66 in housing 62. FIG. 2 shows cavity 74 and holes 70, 78, and 88 schematically in broken lines and in only one housing half 70, for illustrative purposes.

Nozzle block 30 can be a splitter nozzle block. Nozzle block 30 includes two inlet openings 102 on opposite sides of nozzle block 30. Each inlet opening 102 matches up with a corresponding outlet 78 of housing halves 70. Each inlet opening 102 can be formed by a corresponding trunnion 102 (ear), which can serve to anchor nozzle block 30 to housing halves. Nozzle block 30 further includes an outlet opening 104. Inside nozzle block 30 can be bores extending from the inlet openings 102 to a central bore extending to outlet opening 104, the inlet bores being essentially coaxial with one another but perpendicular to the outlet bore. The inlet and outlet bores can have a circular cross-section; alternatively, the outlet bore can have a flat bottom for press fit with nozzle 30. The base and catalyst 32, 34 flowing from separate housing halves 70 mix in nozzle block 30 (nozzle block 30 serving as a mixer or mixing head); this mixture forms the epoxy resin, which exits dispenser 28 through outlet opening 104 of nozzle block 30. In an alternative embodiment, trunnions can be omitted (as shown in FIG. 10), and nozzle block 30 without trunnions can be press fit into housing 62 and thereby secured thereto. If a nozzle block 30 without trunnions is used, each housing half outlet 78 can be formed so as not to include a mating portion for a trunnion of the nozzle block 30.

The two valve assemblies 64 are at least substantially identical. Thus, a description of one valve assembly 64 serves as a description of the other. Each valve assembly 64 is a ball valve assembly 64. As such, each ball valve assembly 64 includes a ball valve 38, ball valve seats 84, and a ball valve spacer 86. Each ball valve 38 is seated between the two ball valve seats 84; each ball valve seat 84 can also serve as a seal. The two ball valves 38 within housing 62 are arranged parallel relative to one another; more specifically, the flow paths of the base and catalyst components 32, 34 are separate but parallel to one another until the flow paths turn at the base of the respective L-shaped cavities 74 and join one another in the nozzle block 30. Each ball valve 38 has a through-hole 108 through which a corresponding base or catalyst component 32, 34 can flow. Each ball valve 38 includes a recess 110 in an exterior side thereof, the recess 110 being used, in conjunction with projections 112 of the ball valve shaft 96, to pivot the ball valve 38 to open and close the flow path of the ball valve 38, as explained further below. Each recess 110 has a shape that matingly receives and couples with a corresponding projection 112 of the valve shaft 96. Each ball valve assembly 64 is positioned and thereby disposed within a corresponding cavity 74 of the housing halves 70. FIGS. 2, 5, and 6 show in broken lines the cavity 74 for placement of the ball valve assembly 64. FIG. 6 shows schematically ball valve assembly 65 (that is, ball valve 38, both ball valve seats 84, and ball valve spacer) in cavity 74. Cavity 74 includes a further recess for receiving a flange on the most distal one of the ball valve seats 84. The ball valve spacer 86 serves to retain the ball valve 38 and the ball valve seats 84 in cavity 74. Thus, ball valve assemblies 64 together with cavities 74 of housing halves 70 form fluid flow paths and thereby are configured for transmitting therethrough respectively the base and catalyst materials so as to form the epoxy resin in nozzle block 30. Arrows 32, 34 show the fluid flow directions of the base and catalyst components (which are also designated by reference characters 32 and 34), which are separate from one another until they reach nozzle block 30. Alternatively, ball valve assemblies 64 can omit the ball valve spacer 86.

Endplate 44 is attached to the proximal end of housing 62, the nozzle block 30 being attached to the distal end of housing 62. Endplate 44 is disposed between housing 62 and air cylinder assembly 52. Endplate 44 can be formed by blank casting, and the various holes in endplate 44 can be drilled and tapped as necessary. Endplate 44 is attached to housing 62 using threaded bolts, as shown in FIG. 2. Endplate 44 has a generally triangularly shaped body with an upwardly extending neck. The body of endplate 44 has a distal face and a proximal face. Body includes holes 114, 116, 118, 120, 122, and 124, as shown in FIG. 8. Holes 114 threadably receive threaded fittings (not shown) of hoses 40 and thereby provide respective passageways for the catalyst and base materials 32, 34 to enter cavities 74 of housing 62 from hoses 40. Holes 116 are through-holes and receive threaded bolts which pass therethrough and secure endplate 44 to housing 62 via threaded holes 164 in housing half 70. Hole 118 can be used as a grease insertion hole to insert grease into central cavity 90; more specifically, hole 118 can be drilled and taped for a Zerk fitting for insertion of a lubricant. Alternatively, endplate 44 need not have a grease insertion hole at all, as indicated in FIG. 10. Alternatively, hole 118 can serve as a grease overflow outlet hole. Holes 120 are blind holes which threadably receive bolts to fixedly connect air cylinder 126 to the proximal face of endplate 44. Hole 122 is a through-hole which accommodates a bushing 128 and a snap-ring 130. Bushing 128 has a through-hole which permits passage and back-and-forth movement of rod 66 therethrough, rod 66 connecting to and being driven by piston 132 of air cylinder assembly 52. Hole 124 is an L-shaped through-hole that is threaded at one end. Hole 124 runs from an external inlet 124A on one of the upwardly slanted shoulders of endplate 44 to an outlet 124B on the proximal side of endplate 44, the outlet 124B emptying air into air cylinder 126 on the distal side of piston 132; this outlet 124B is thus inside the wall of air cylinder 126. Inlet 124B of hole 124 can be threaded so as to receive a threaded fitting of an air hose 50 running from the air supply 48 such that hole 124 provides a passageway for air to enter air cylinder 126 on the distal side of piston 132. Hole 46 can be a through-hole for a quick-pin (not shown); the operator can use a quick-pin to connect tubing of the aforedescribed rod/stem (i.e., square tubing) to the neck of endplate 44; alternatively, hole 46 can be two oppositely facing blind holes in the neck, the quick-pin being used to secure the tubing of the rod/stem to the neck.

Air cylinder assembly 52 includes an air cylinder 126 and a piston 132 which moves within cylinder 126. Air cylinder 126 is coupled with housing 62. Air cylinder 126 can be fastened directly to endplate 44 using bolts through holes 120. Alternatively, air cylinder 126 can be fastened directly to housing 62. FIGS. 1 and 2 show that these bolts extend through longitudinally extending wings on the lateral sides of air cylinder 126; by contrast, the wings of the embodiment of dispenser 28 in FIG. 10 are relatively short in their longitudinal extent compared to the length of the wings in FIGS. 1 and 2. While fasteners are not shown in FIG. 10, it is understood that bolts extend through the air cylinder 126 wings like in FIGS. 1 and 2 to attach air cylinder 126 to endplate 44. Air cylinder 126 includes air supply hole 54 which includes threads for threadably receiving a fitting of air supply hose 50. Air of air supply arrangement 24 is received in air supply hole 54 to push piston 132 in a proximal-to-distal direction, as shown by arrow 134. As indicated above, air supplied to air cylinder 126 via hole 124 is used to push piston 132 back in a distal-to-proximal direction, which is opposite the direction of arrow 134. An O-ring seat can be provided at the distal end of air cylinder 126, the O-ring seat receiving an O-ring in order to seal any gap between air cylinder 126 and endplate 44. The two-way reciprocating piston 132 includes a circumferential groove in which a seal is provided, the seal sealing any gap between piston and the inner surface of air cylinder 126. As indicated below, the movement of piston 132 moves rod 66, which causes rack gear 92 to move as well. Piston 132 threadably receives rod 66 in a distal end of a longitudinally extending cylindrical portion of piston 132; a set screw, which can extend transversely in a proximal end of a longitudinally extending cylindrical portion of piston 132, can be used to further secure rod 66 and piston 132 together. Bushing 128 can be a carbon fiber bushing which is inserted in endplate 44, as indicated in FIGS. 2 and 8. Bushing 128 provides a bearing for movement of rod 66 through endplate 44. Snap ring 130 snaps into a groove 131 in endplate 44 between a proximal end of bushing 128 and the proximal face of endplate 44 (groove 131 is shown in FIG. 11 but is not shown in FIG. 8 for the sake of clarity); snap ring 130 (which is not shown in FIG. 8 for the sake of clarity) serves at least in part to hold bushing 128 in endplate 44. Thus, bushing 128 is prevented from exiting the proximal end of endplate 44 by snap-ring 130 situated in a snap-ring groove 131 in hole 122. Air cylinder assembly 52 is thus configured for driving rod 66 and actuator assembly 68 to open and close valves 38. Rather than using an air cylinder 126, a hand lever (not shown) can be substituted for the air cylinder 126 so as to move the rod 66 back-and-forth.

A single rod 66 connects piston 132 with rack gear 92 and is driven by piston 132 to selectively move rack gear 92 in a distal direction and conversely in a proximal direction as well. This movement, as explained below, ultimately pivots ball valves 38 to open and close the flow paths of ball valves 38 (the flow paths flowing through the through-hole of ball valves 38). Rod 66 is threadably received by piston 132 and is also threadably received by rack gear 92; rod 66 is connected at its opposing ends directly to piston 132 and rack gear 92 respectively. Rod 66 extends through hole 122 of endplate 44 and thus also through a through-bore of bushing 128. Dispenser 28 includes only one rod 66. Rod 66 is the only connection between the driving mechanism 52 and the actuator assembly 68, the driving mechanism 52 in the embodiments shown in the drawings being the air cylinder assembly 52; it is understood that the driving mechanism instead could be a hand lever rather than an air cylinder.

Actuator assembly 68 is positioned within housing 62 and includes only one rack gear 92, only one valve gear 94, only one valve shaft 96, and two bushings 136, which can be carbon fiber bushings. An advantage of actuator assembly 68 shown in the drawings and described herein is that no retaining rings, bushings, seals are required to drive ball valves 38 except for what is shown in the drawings and described herein. Further, the actuator assembly 68 does not require a nut, a grounding spring, a plurality of coupling screws or bolts, or a coupling for coupling two shafts together. Stated another way, dispenser 28 does not require additional parts beyond what is shown in the drawings and described herein. Hole 88 may have a seal thereabout. Rack gear 92 is an elongate piece having a plurality of gear teeth 138 which run substantially parallel relative to one another. Gear teeth 138 run transverse to the longitudinal extent of rack gear 92. Gear teeth 138 of rack gear 92 mate with gear teeth 140 of valve gear 94, which can be a type of spur gear. In the proximal face of rack gear 92 is a threaded blind hole which threadably receives the distal end of rod 66. This blind hole runs parallel to the longitudinal axis of rack gear 92 and is generally centered in the proximal face of rack gear 92 but can be displaced slightly up from dead center of the proximal face, the proximal face including the most proximal tooth as well. Rod 66 can, for example, extend into rack gear 92 a distance of about three teeth 138. Rack gear 92 is selectively moved in a proximal-to-distal direction and conversely in a distal-to-proximal direction in order to pivot valve gear 94 counter-clockwise and also clockwise, when viewing valve gear 94 in the direction of arrow 42 in FIG. 2. The teeth 138 of rack gear 92 mate with and are configured for driving the teeth 140 of valve gear 94.

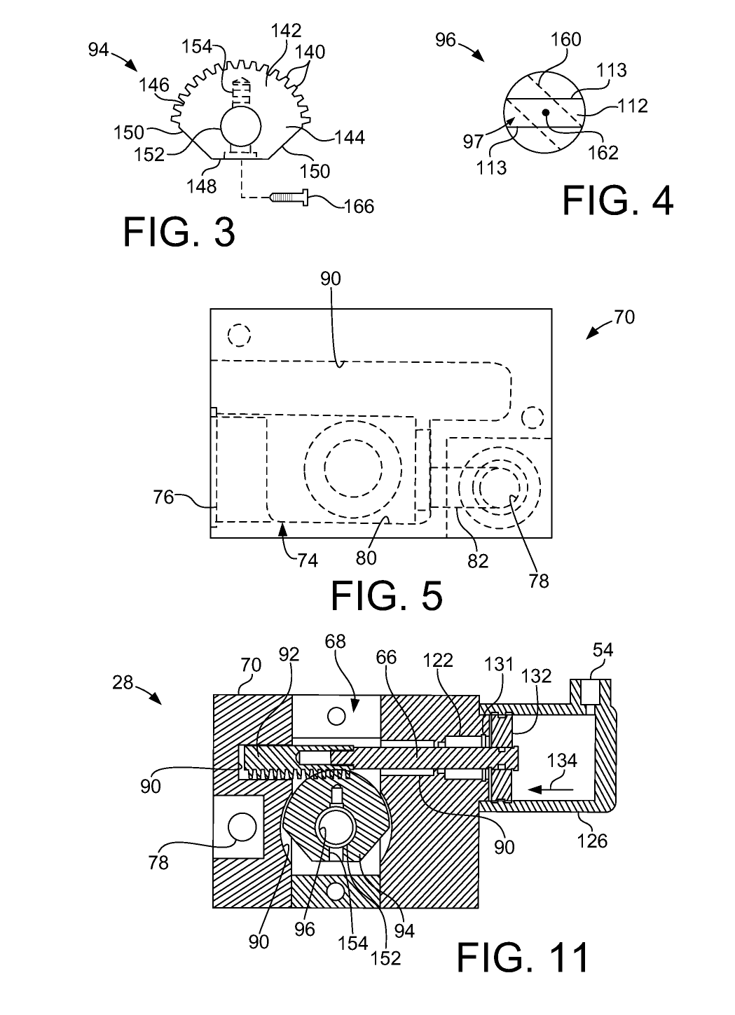

Valve gear 94 includes a plurality of gear teeth 140 running substantially parallel relative to one another and substantially parallel to gear teeth 138 of rack gear 92. Valve gear 94 includes a generally half-circle portion 142 and a trapezoidal portion 144, these portions being formed monolithic with one another. The half-circle portion includes a convex wall 146 with the gear teeth 140 formed thereon. The trapezoidal portion 144 has a base 148 which is shorter than the portion of trapezoidal portion 144 which is coextensive with the linear portion of the half-circle portion 142. The legs 150 of the trapezoidal portion 144 proceed at a forty-five degree angle in a downward direction from the ends of the half-circle portion 142 to the base 148 of the trapezoidal portion 144. The legs 150 can be otherwise referred to as first and second straight walls 150 which are disposed at ninety degrees relative to one another; the convex wall 146 extends between the legs 150. A through-bore 152 is formed transversely in valve gear 94 running generally parallel to gear teeth 140. Through-bore 152 has a circular cross-section, the upper half of the circular cross-section being formed in the half-circle portion 142 of the valve gear 94, the lower half of the circular cross-section being formed in the trapezoidal portion 144 of the valve gear 94. Further, the circular cross-section is centered between the left and right extents of the junction between the half-circle portion 142 and the trapezoidal portion 144, when viewing the valve gear 94 from one end of the through-bore 152. The bottom of the valve gear 94 (which forms the base 148 of the trapezoidal portion 144) has a blind hole 154 centered and formed therein, the blind hole 154 forming a seat for a threaded bolt which is used to directly connect valve gear 94 and valve shaft 96 together. Bolt hole 154 runs transversely through through-hole 152 of valve gear 94, as shown in FIG. 3. Bolt hole 154 can include a shoulder for the bolt head of a bolt 166, as shown in FIG. 3; in one embodiment of the invention, the bolt head must be less than 0.25 inches deep. That portion of bolt hole 154 being above through-bore 152 is threaded; thus, bolt hole 154 threadably receives the bolt 166 which connects valve gear 94 and valve shaft 96 together. Valve gear 94 is configured for rotating valve shaft 96 to thereby pivot simultaneously the two ball valves 38 using the projections 112 of the valve shaft 96 and the corresponding recesses 110 of the ball valves 38; that is, as valve gear 94 rotates, valve shaft 96 simultaneously rotates since valve gear 94 and valve shaft 96 are fixedly connected together. FIG. 11, which shows an alternative embodiment of dispenser 28 (corresponding parts have same reference characters as FIGS. 1-10, even if the parts are somewhat different), shows valve gear 94 schematically; thus, it is understood that valve gear has teeth 140. Further, FIG. 11 shows that housing 62 includes a cutout adjacent valve gear 94 to accommodate pivoting movement of valve gear 94.

Valve shaft 96 is a single rigid shaft. Valve shaft 96 is directly connected to the ball valves 38 and is thereby configured for simultaneously opening and closing the ball valves 38. Valve shaft 96 is generally cylindrical in shape and includes projections 112 (which can also be referred to as tongues 112) on each of the two longitudinal ends 97 of the valve shaft 96. Each projection 112 directly connects to corresponding ball valve recesses 110 by being directly received in recesses 110, the recesses 110 being formed in the exterior side of the sphere of each ball valve 38. Thus, only one linear valve shaft 96 extends between ball valves 38. Each projection 112 has a curvature projecting away from the valve shaft 96; stated another way, each projection 112 can be radiused with a convex curvature. Each projection 112 has top and bottom ledges 113 which are substantially parallel to one another, as shown in FIGS. 2, 4, and 10. As shown in FIGS. 2, 9, and 11, each recess 110 has a shape that matingly receives a corresponding projection 112 of the valve shaft 96. Thus, each recess 110 has parallel flat walls 156 which correspond to the top and bottom ledges 113 of each projection 112. Further, each recess 110 has a concave wall 158 situated between the parallel flat walls 156, the concave wall 158 matingly accommodating the convex wall 146 of the projection 112.

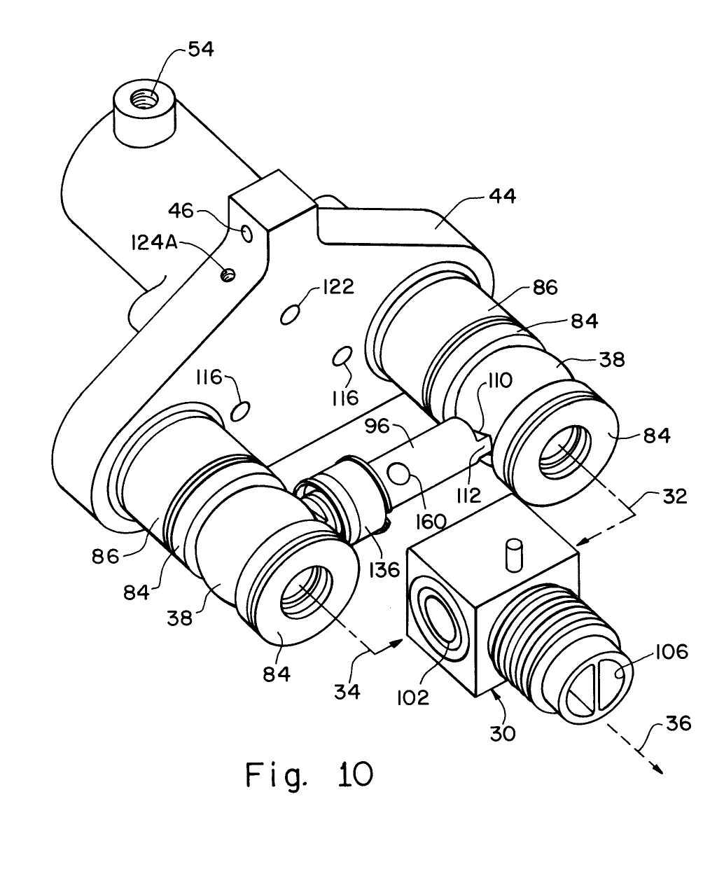

Valve shaft 96 extends transversely through valve gear 94, valve gear 94 being fixed about valve shaft 96. Valve shaft 96 also includes a cylindrical through-hole 160 which is used to fix valve shaft 96 and valve gear 94 to one another. As indicated above and in FIG. 3, a bolt 166 is inserted into bolt hole 154 of valve gear 94. This bolt 166 passes through through-hole 160 of valve shaft 96 and is then threaded into the valve gear 94. Valve shaft through-hole 160 can be oriented perpendicular to the flat and parallel top and bottom ledges 113 of projections 112 (as shown in FIG. 2), the top and bottom ledges 113 then being parallel with the base 148 of valve gear 94. In this orientation, the home position for valve gear 94 (when ball valve 38 is closed) can be when the base 148 of valve gear 94 is generally parallel with the axis of movement of rod 66; the home position then for rack gear 92 can be when its distal tooth 138 is generally adjacent the tooth 140 that is midway between the most distal tooth 140 of valve gear 94 and the most proximal tooth 140 of valve gear 94. In this position, the most distal tooth 140 can be said to occupy the 9 o'clock reference position, and the most proximal tooth 140 can be said to occupy the 3 o'clock reference position (the 12 o'clock position of the reference clock of the valve gear 94 occupying the top dead center position shown in FIG. 2 and being that portion of the reference clock in contact with rack gear 92). In this orientation, the recess 110 of each ball valve 38 can be oriented at a ninety-degree angle to the direction of flow through each ball valve 38; this orientation of the recess 110 is shown in FIG. 2. Alternatively, recess 110 can be parallel to the direction of through-bore 108 through ball valve 38; such an orientation of the recess 110 on ball valve 38 is shown in FIGS. 9 and 10. In this orientation, the home position can be when the most distal tooth 138 of rack gear 92 is essentially adjacent the most distal tooth 140 of valve gear 94 (the valve gear tooth 140 that is in the left-most position when viewing FIG. 2); that is, valve gear 94 is rotated such that the most distal tooth 140 of valve gear 94 in FIG. 2 occupies the 12 o'clock reference position when ball valve 38 is closed. As rack gear 92 is pushed distally by piston 132 and rod 66, valve gear 94 rotates counter-clockwise (viewing in the direction of arrow 42 in FIG. 2) such that the most distal tooth 140 of valve gear 94 proceeds distally; in so doing, ball valve 38 is pivoted to the open position. In this embodiment, again, valve shaft through-hole 160 can be oriented perpendicular to the flat and parallel top and bottom ledges 113 of projections 112, the top and bottom ledges 113 then being parallel with the base 148 of valve gear 94. Alternatively, valve-shaft through-hole 160 can be oriented at a forty-five degree angle to the top and bottom ledges 113 of projections 112, the top and bottom ledges 113 then being oriented at a forty-five degree angle to the base 148 of valve gear 94 as well; this orientation is shown in FIGS. 4 and 10. In this orientation, the home position for valve gear 94 (when ball valve 38 is closed) can be when the base 148 of valve gear 94 is generally parallel with the axis of movement of rod 66. The home position for rack gear 92 can be when its distal tooth 138 is generally adjacent the tooth 140 that is midway between the most distal tooth 140 of valve gear 94 and the most proximal tooth 140 of valve gear 94. In this orientation, the recess 110 of each ball valve 38 can be oriented at a forty-five degree angle to the direction of flow through each ball valve 38. Alternatively, valve-shaft through-hole 160 can be oriented at a forty-five degree angle to the top and bottom ledges 113 of projections 112, the top and bottom ledges 113 then being oriented at a forty-five degree angle to the base 148 of valve gear 94 as well, as shown in FIGS. 4 and 10. In this orientation, the home position for valve gear 94 (when ball valve 38 is closed) can be when the most distal tooth 140 of valve gear 94 is rotated clockwise so as to occupy the position on the reference clock midway between 10 o'clock and 11 o'clock (the 10.5 o'clock position). Stated another way, the most distal tooth 140 of valve gear 94 can be at forty-five degrees to the left of the 12 o'clock position on the reference clock. Further, in this home position, the most distal tooth 138 of rack gear 92 can be adjacent valve gear 94 (i.e., adjacent the 12 o'clock position of the reference clock for the valve gear 94). Further, in this orientation, the recess 110 can be parallel to the direction of through-bore 108 through ball valve 38. This orientation of valve gear 94 and recess 110 is shown in FIG. 10. These alternatives are provided by way of example and not by way of limitation. In each of these embodiments, through-hole 160 of valve shaft 96 has a circular cross-section, is centered along the longitudinal extent of valve shaft 96, and has a center axis which passes through the longitudinal axis 162 of valve shaft 96. Further, in each of these embodiments, in the home position ball valves 38 can be in the closed position. Each ball valve 38 rotates counter-clockwise in FIG. 2 (viewing in the direction of arrow 42 in FIG. 2) to move from a closed position to an open position and, conversely, clockwise to move from an open position to a closed position. It is noted that the ball valves 38 are opened and closed together and thus simultaneously; that is, when one ball valve 38 opens for example, the other ball valve 38 simultaneously opens, and when one ball 38 closes the other ball valve 38 simultaneously closes.

Bushings 136 each can be a carbon fiber bushing which is inserted in corresponding holes of housing halves 70. Each bushing 136 is substantially identical relative to one another; thus, a description of one bushing 136 serves as a description of the other. Each bushing 136 provides a bearing 136 for reciprocal rotation therein of a corresponding portion of valve shaft 96. Each bushing 136 includes a through-bore which has a stepped diameter therein; stated another way, approximately one-half of the through-bore has a constant but greater diameter than the other half of the through-bore, which also has a constant diameter. FIGS. 2 and 6 show the through-bore of the bushings 136. FIGS. 2 and 6 show the reduced diameter portion of the bushing 136 being oriented toward the valve gear 94, while the greater diameter portion is oriented toward the ball valve 38; this orientation can be reversed if so desired such that the greater diameter portion of the bushing 136 is oriented toward the valve gear 94 while the reduced diameter portion is oriented toward the ball valve 38.

In use, hoses 40 with their fittings are connected to holes 114, these hoses 40 separately providing the base and catalyst components 32, 34 to dispenser 28 under pressure. Air supply hoses 50 with their fittings are also connected respectively to air inlet 54 of air cylinder 126 and air inlet 124A of endplate 44. The ball valves 38 are in their closed position until epoxy resin is desired by the operator. Central cavity 90 can be provided with a lubricant such as grease. When operator desires resin to be dispensed from nozzle block 30 of dispenser 28, operator can for instance press a corresponding button on a remote trigger assembly 26 in order to open the ball valves 38. The ball valves 38 are rotated ninety degrees from their closed position to their open position when air is supplied to air inlet 54 of air cylinder 126. This supply of air pushes piston 132 in a proximal-to-distal direction (“proximal” being the air cylinder 126 end of dispenser 28 and “distal” being the nozzle 30 end of dispenser 28). Piston 132 and rod 66 being directly connected to one another in a fixed manner, this movement of piston 132 causes rod 66, which slides in bushing 128 inserted in endplate 44, to move in a proximal-to-distal direction. Rod 66 and rack gear 92 being directly connected to one another in a fixed manner, this movement of rod 66 forces rack gear 92 to move in a proximal-to-distal direction. Rack gear 92 and valve gear 94 (which can be referred to as a spur gear 94) being directly and matingly connected to one another via their respective sets of gear teeth 138 and 140, rack gear 92 causes valve gear 94 to rotate or pivot counter-clockwise, viewing valve gear 94 in the direction of arrow 42 in FIG. 2 (as well as FIG. 11). Valve gear 94 and valve shaft 96 being directly and fixedly connected to one another, the rotation of valve gear 94 causes valve shaft 96 to also rotate or pivot with valve gear 94 and thus to pivot counter-clockwise as well. The distal end of the rack gear 92 slide area of central cavity 90 can stop the proximal-to-distal progression of rack gear 92 to the extent that the dosage of air in air cylinder 126 via air inlet 54 would otherwise tend to push rack gear 92 beyond this distal end of the rack gear 92 slide area of central cavity 90. Projections 112 of valve shaft 96 being respectively inserted into and thereby directly connected to recesses 110 of ball valves 38, the rotation of valve shaft 96 causes ball valves 38 to rotate or pivot with valve shaft 96 and thus to simultaneously pivot counter-clockwise as well. The pressurized base and catalyst components 32, 34 then flow through the through-bore 108 of the respective ball valves 38, as well as the bores of the valve seats 84 and valve spacer 86. The base and catalyst components 32, 34 then flow into a reduced diameter bore of the respective housing halves 70, make a right-angled turn, then flow into the nozzle block 30, and then flow out of the mixing nozzle outlet 106 to the desired place for the epoxy resin 36.

When the operator wishes for the epoxy resin 36 to stop flowing, the operator can selectively press a button on the remote trigger assembly 26 to cause the ball valves 38 to rotate back and thereby close. Alternatively, the shot-size of epoxy resin 36 can be set by the operator, and the exact dosage can be repeated each time the operators presses a switch associated with the remote trigger assembly 26; consequently, a switch would not necessarily be needed to return the valves 38 to their closed position. Further, an abort switch can be provided to obtain small dollops of epoxy resin 36 for touch-up. The rotation backwards of the ball valves 38 is caused by air flowing through hose 50 and into inlet 124A on endplate 44, the air flowing through right-angled through-bore 124 in endplate 44 and then out of this bore 124 via outlet 124B and into air cylinder 126 on the other side of piston 132, as compared to the side that air from inlet 54 flows relative to piston 132. This flow of air causes piston 132 to retreat by moving in a distal-to-proximal direction. This movement of piston 132 causes rod 66 to move in a distal-to-proximal direction. This movement of rod 66 causes rack gear 92 to move in a distal-to-proximal direction. This movement of rack gear 92 causes valve gear 94, and thus also valve shaft 96, to rotate or pivot in a clockwise direction, viewing valve gear 94 and valve shaft 96 in the direction of arrow 42 in FIG. 2 (as well as FIG. 11). The proximal end of the rack gear 92 slide area of central cavity 90 can stop the distal-to-proximal progression of rack gear 92 to the extent that the dosage of air in air cylinder 126 via air inlet 124 would otherwise tend to push rack gear 92 beyond this proximal end of the rack gear 92 slide area of central cavity 90. As valve shaft 96 rotates in a clockwise direction, each of the ball valves 38 are also caused to rotate simultaneously in a clockwise direction ninety-degrees and thereby to be moved into a closed position. When the ball valves 38 are closed, the base and catalyst components 32, 34 are prohibited from flowing to the mixing nozzle 30.

The present invention further provides a method for dispensing a fluid 36 under high pressure. The method includes the following steps: providing a dispenser 28 including a housing 62, two valves 38 within the housing 62 and arranged parallel relative to one another, and an actuator assembly 68 within the housing 62 and including a single rigid shaft 96; connecting the shaft 96 to the valves 38; opening simultaneously the valves 38 with the shaft 96; and closing simultaneously the valves 38 with the shaft 96. The dispenser 28 receives a base and a catalyst 32, 34, mixes the base and said catalyst 32, 34 together to form an epoxy resin 36, and dispenses the epoxy resin 36 therefrom. The actuator assembly 68 further includes a valve gear 94 and a rack gear 92, the rack gear 92 mating with and driving the valve gear 94, the shaft 96 extending transversely through the valve gear 94, the valve gear 94 being fixed about the shaft 96. Each of the valves 38 is a ball valve 38. The shaft 96 includes two longitudinal ends 97 each including a projection 112, each ball valve 37 including a recess 110 which matingly couples with a respective projection 112. The method can further include the step of rotating the shaft 96 with the valve gear 94 to thereby pivot simultaneously the ball valves 38 using the projections 112 and recesses 110. The housing 62 includes a first cavity 90, a second cavity 74, and a third cavity 74, the rack gear 92, the valve gear 94, and the shaft 96 being disposed within the first cavity 90 which is generally between the second and third cavities 74, the ball valves 38 being respectively disposed within the second and third cavities 74, the second and third cavities 74 forming fluid flow paths 32, 34 and thereby transmitting therethrough respectively a base and a catalyst 32, 34 to form an epoxy resin 36. The dispenser 28 further includes an endplate 44, an air cylinder assembly 52, and a rod 66, the endplate 44 being disposed between the housing 62 and the air cylinder assembly 52, the air cylinder assembly 52 including a piston 132 therein, the rod 66 extending through a through-hole 122 in the endplate 44 and being connected at opposing ends of the rod 66 respectively to the rack gear 92 and the piston 132, the air cylinder assembly 52 driving the rod 66 and the actuator assembly 68 to open and close the valves 38. The valve gear includes a first straight wall 150, a second straight wall 150, and a convex wall 146 with a plurality of teeth 140, the first and second straight walls 150 disposed at about ninety degrees relative to one another, the convex wall 146 extending between the first and second straight walls 150.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A dispenser for dispensing a fluid under high pressure, said dispenser comprising:
a housing;
two valves within said housing and arranged parallel relative to one another; and
an actuator assembly within said housing and including a single rigid shaft which is connected to said valves and is configured for simultaneously opening and closing said valves.

2. The dispenser of claim 1, wherein the dispenser is configured for receiving a base and a catalyst, for mixing said base and said catalyst together to form an epoxy resin, and for dispensing said epoxy resin therefrom.

3. The dispenser of claim 1, wherein each of said valves is a ball valve.

4. The dispenser of claim 3, wherein said shaft includes two longitudinal ends each including a projection, each ball valve including a recess which matingly couples with a respective said projection.

5. The dispenser of claim 4, wherein said shaft is configured for pivoting simultaneously said ball valves using said projections and recesses.

6. The dispenser of claim 5, wherein said housing includes a first cavity, a second cavity, and a third cavity, said actuator assembly being disposed within said first cavity which is generally between said second and third cavities, said ball valves being respectively disposed within said second and third cavities, said second and third cavities forming fluid flow paths and thereby being configured for transmitting therethrough respectively a base and a catalyst to form an epoxy resin.

7. The dispenser of claim 6, further comprising an air cylinder assembly configured for driving said actuator assembly to open and close said valves.

8. A method of dispensing a fluid under high pressure, said method comprising the steps of:
providing a dispenser including a housing, two valves within said housing and arranged parallel relative to one another, and an actuator assembly within said housing and including a single rigid shaft;
connecting said shaft to said valves;
opening simultaneously said valves with said shaft; and
closing simultaneously said valves with said shaft.

9. The method of claim 8, wherein said dispenser receives a base and a catalyst, mixes said base and said catalyst together to form an epoxy resin, and dispenses said epoxy resin therefrom.

10. The method of claim 8, wherein each of said valves is a ball valve.

11. The method of claim 10, wherein said shaft includes two longitudinal ends each including a projection, each ball valve including a recess which matingly couples with a respective said projection.

12. The method of claim 11, further comprising the step of pivoting simultaneously said ball valves using said projections of said shaft and recesses.

13. The method of claim 12, wherein said housing includes a first cavity, a second cavity, and a third cavity, said actuator assembly being disposed within said first cavity which is generally between said second and third cavities, said ball valves being respectively disposed within said second and third cavities, said second and third cavities forming fluid flow paths and thereby transmitting therethrough respectively a base and a catalyst to form an epoxy resin.

14. The method of claim 13, wherein said dispenser further includes an air cylinder assembly configured for driving said actuator assembly to open and close said valves.
